(19) United States
(12) Patent Application Publication
(10) Pub. No.: US 2021/0032848 A1
(43) Pub. Date: Feb. 4, 2021

(54) METHOD FOR AN AUTOMATIC MOVEMENT OF A WORKING DEVICE AND WORKING DEVICE

(71) Applicant: LIEBHERR HYDRAULIKBAGGER GMBH, Kirchdorf (DE)

(72) Inventors: Hannes WIND, Stuttgart (DE); Oliver Sawodny, Stuttgart (DE); Anton Renner, Stuttgart (DE); Ferdinand Hofmann, Kirchdorf (DE)

(21) Appl. No.: 16/942,689

(22) Filed: Jul. 29, 2020

(30) Foreign Application Priority Data
Jul. 31, 2019 (DE) 10 2019 120 633.2

(51) Int. Cl. E02F 9/20

(52) U.S. Cl. CPC E02F 9/2041; E02F 3/32

(57) ABSTRACT

The application relates to a method for an automatic movement of a working device that comprises a control and at least two components movable independently of one another by means of a respective one actuator controllable by the control. The control has a learning mode and a work through mode, wherein the working device is automatically traveled from a first position into a second position by a corresponding control of the actuators in the work through mode. In the learning mode, the control detects data relating to the individual movements of the components during a movement of the working device and stores them, with the control of the actuators taking place during the automatic movement on the basis of these data in the work through mode. A parameter of the automatic movement is settable by the operator. The application further relates to a working device carrying out of the method application.

### CROSS REFERENCE TO RELATED APPLICATION

The present application claims priority to German Patent Application No. 10 2019 120 633.2 filed on Jul. 31, 2019. The entire contents of the above-listed application is hereby incorporated by reference for all purposes.

### TECHNICAL FIELD

The present application relates to a method for an automatic movement of a working device, in particular of a material transfer machine or an earth-moving machine, in accordance with the preamble of claim 1 and to a working device having a control for carrying out the method in accordance with the application.

It is frequently the case that when working with working devices such as material transfer machines or earth-moving machines, repetitive work procedures are carried out such as the taking up of a load at a first position and the unloading of the load taken up at a second position.

Such repeating work procedures can typically be roughly divided into four substeps. First material or a load is taken up by the working device at a first position. The material taken up is subsequently traveled to a second position by a corresponding movement of the working device. In the next step, the material is unloaded at the second position. Finally the working device is traveled back to the first position again so that it is ready for a repeat taking up of material.

This sequence of steps can then be repeated. The first position in this process at which the material or the load is taken up can remain the same for each workstep or it can change—e.g. if new material has to be taken up at a different point. The same applies to the second position if the position of the unloading changes from workstep to workstep. The movement of the working device between the take-up and unloading positions during the taking up and unloading of material from the previous take-up and unloading positions is in contrast only dependent on the starting and end positions of the current movement.

The worksteps presented above are typically carried out manually by the operator of the working device. It would, however, be desirable due to the repetitive character of such work procedures if they could be carried out at least partially in an automated manner. It would furthermore be advantageous to be able to adapt such an automatic working movement to the current conditions or demands.

It is therefore the underlying object of the present application to provide a method that enables an automation of such work procedures of a working device and simultaneously allows the operator to influence the movement routine carried out automatically.

This object is achieved in accordance with the application by a method having the features of claim 1. The method in accordance with the application is accordingly a method for an automatic movement of a working device, in particular of a material transfer machine or an earth-moving machine, wherein the working device comprises a control and at least two components. The components can each be moved independently of one another by means of an actuator controllable or actuable by the control. The control has a learning mode and a work through mode, wherein the working device is automatically traveled from a first position into a second position by a corresponding control of the actuators in the work through mode. The operator of the working device can here in particular switch over between the learning mode and the work through mode.

In accordance with the application, in the learning mode the control detects data relating to the individual movements of the components during the performance of a movement of the working device and stores them under certain criteria. The control of the actuators in the automatic movement of the working device in the work through mode then takes place on the basis of these data, with at least one parameter of the automatic movement of the working device being able to be changed or set by the operator of the working device to influence it.

The operator switches into the learning mode to program or teach a movement of the working device that is to be carried out automatically later. A movement thereupon carried out is detected by the control and corresponding information that characterizes this movement, in particular trajectories of the different actuators, is stored. These data are available for later automatic work procedures.

The detection of the movement to be “learned” in the learning mode can take place, for example, during a movement of the working device manually performed by the operator. Provision can likewise be made that certain operating patterns of the operator are detected and recorded and are evaluated by the control during the performance of work with the working device, with repeating work cycles being recognized and corresponding trajectories of the actuators moving the components being generated that are then automatically worked through in the work through mode.

The operator switches into the work through mode for the automatic carrying out of the movement detected in the learning mode. The control of the actuators thereupon takes place on the basis of the data stored by the control, in particular on the basis of trajectories of the actuators recorded in the learning mode. It is possible in this respect that the automatically performed movement relates to a movement from a starting position into an end position or that the working device is moved to and fro between a starting position and an end position. Provision can furthermore be made that the operator can intervene manually at any time during the automatic movement procedure and can stop or override the automatic movement.

In accordance with the application, the operator can furthermore change or set at least one parameter of the automatic movement of the working device such as the speed of the actuators, for example by means of an input means connected to the control. The movement performed automatically in the work through mode can thereby be adapted to different working and/or environmental conditions, to the material to be taken up or to other factors. It is furthermore conceivable that the operator can perform corrections of the automatically performed movement manually in the work through mode so that he can, for example, influence or change the starting and/or end positions while the movement between these positions continues to be performed automatically.

The input means can be a separate apparatus or an already existing input means provided for the manual operation of the working device (e.g. one or more master switches).

In the present case, the term actuator designates every form of technical drive assembly that is used in the working device for moving a component. It can here be an actuator working hydraulically, pneumatically, electrically, or in another manner. The moving component can e.g. be a slewably supported superstructure, a boom, a stick, a tool, or any other desired movable component.

Advantageous embodiments of the application result from the dependent claims and from the following description.

Provision is made in an embodiment that the adjustable parameter is a maximum or minimum speed of one or more actuators, a minimum energy input, a shortest or fastest distance or a distance optimized using other criteria or a position, in particular a starting or end position, of the working device.

Provision is made in a further embodiment that the control detects the trajectories of the actuators at discrete time intervals in the learning mode, with the detected data comprising the instantaneous positions and optionally the instantaneous speeds of the actuators. The increment of the temporal discretization here determines the accuracy of the detection of the trajectories and the data volume arising in this process. At each discrete time step, the trajectories are evaluated and the instantaneous position and the instantaneous speed of the actuators are detected. A trajectory thus results for every actuator contributing to the recorded movement of the working device that represents the progression of the actuator position or disposition in dependence on time. A corresponding sensor system is optionally provided for this purpose to measure these data and to provide them to the control.

Provision is made in a further embodiment that the control stores instantaneous actuator positions as characteristic points for every trajectory detected in the learning mode, with the control optionally classifying an instantaneous actuator position at a specific point in time as a characteristic point if at least one condition with respect to the instantaneous actuator speed is satisfied. Characteristic points are actuator positions distinguished from other actuator positions (“points”). The characteristic points include the actuator positions at the start and/or at the end of an actuator movement, that is those actuator positions of a trajectory that characterize the movement routines of the associated actuator.

A working through of the movements of the actuators recorded in the learning mode can take place on the basis of the stored characteristic points in the work through mode. The data volume to be stored is thereby reduced since, for example, points of a trajectory during a constant movement or during a standstill of the actuator do not need to be stored.

Depending on the conditions with respect to the instantaneous actuator speed used for classifying characteristic points, further following steps can be advantageous or necessary to carry out a further selection of the characteristic points found in the first step. In this case, only the characteristic points remaining after a corresponding analysis or sorting out are stored by the control.

Provision is made in a further embodiment that the condition is satisfied when the instantaneous speed of the actuator exceeds a first threshold value at the start of an actuator movement or falls below it at the end of an actuator movement and/or if the sign of the instantaneous speed of the actuator changes. The first threshold value can be composed of a plurality of parameters that take account of different aspects such as a hysteresis value. The threshold value or one or more of the parameters entering into the threshold value can be settable by the operator. The detection of the trajectories can thereby be adapted to the current conditions or demands.

Provision is made in a further embodiment that the control only stores those characteristic points whose distance from a directly preceding and/or following characteristic point exceeds a second threshold value. The distance observed is in particular a position distance. As previously addressed, it may occur that too many or unnecessary points are recognized in the first step of determining characteristic points of the trajectories. By sorting out characteristic points that have a small distance from a preceding or following characteristic point (seen in the direction of time of the recorded trajectories), characteristic points are sorted out that result, for example, due to an overshooting of the component moved by an actuator and that are close to one another. This can be a result of the condition that a characteristic point is recognized on a sign change of the instantaneous actuator speed. After the sorting out, the starting and end points of the actuator movements remain that are sufficient to work through the detected movements in the work through mode. The calculation of the trajectories between the stored characteristic points can take place by means of a special calculation method, e.g. a trajectory planning. A planning means can in particular be provided for this purpose.

Provision is made in a further embodiment that, in the learning mode, the control additionally stores the actuator positions not classified as a characteristic point for every trajectory at those times that correspond to the times of the detected characteristic points of the other trajectories. In addition to the characteristic points recognized for a trajectory, this actuator position is additionally stored for every time at which a characteristic point was recognized for one of the other trajectories even though it is here not a characteristic point for the trajectory observed. It is thereby achieved that the times of the actuator positions of a trajectory stored in total correspond to the characteristic actuator positions of the remaining trajectories stored in total. The additionally stored points can also be called synchronization points.

In the work through mode, the characteristic points are traveled to one after the other for every trajectory. A movement routine synchronized overall is ensured by the storage of the synchronization points.

Provision is made in a further embodiment that the control controls the actuators such that all the actuators reach the actuator positions corresponding to one another in time simultaneously within a time window that is optionally settable, with the speed of all the actuators being adapted to the slowest actuator and with the adaptation in particular taking place by means of an iterative process. Alternatively, however, any desired other process can also be used, for example an optimization process. A smooth total movement of the working device is thereby achieved.

Provision is made in a further embodiment that the control controls the different actuators in the work through mode on the basis of the actuator positions stored for every trajectory (they can be the characteristic points alone or together with the synchronization points), with the control comprising a planning means that calculates the trajectories to be worked through automatically on the basis of the stored actuator positions, with the actuators being controlled such that they follow the calculated trajectories. The planning means can be a trajectory planner that plans and/or calculates the trajectory sections between the actuator positions detected and stored in the learning mode. Any desired trajectory planner can be used here. In the work through mode, the trajectories of the actuators newly calculated by the planning means on the basis of the points stored by the control are then worked through.

Provision is made in a further embodiment that the planning means newly calculates the trajectories of the actuators to be worked through in each case sectionwise between two respective adjacent stored actuator positions, with the planning means calculating the next trajectory section up to the then following stored actuator positions as soon as the instantaneous position of an actuator falls below a distance threshold value with respect to the stored actuator position currently traveled to. The distance threshold value can optionally be fixed or set.

If all the trajectories are located within the distance threshold value around the stored actuator positions to be traveled to, the planning or new calculation of the next trajectory sections to the next stored actuator positions to be traveled to takes place. The current reference values of every trajectory are in particular used as the starting values for the trajectories so that a process that is as smooth as possible results. The distance threshold values can here optionally be fixed separately for every point and for every actuator.

Provision is made in a further embodiment that the calculation of the total movement of the working machine and/or of the individual movements of the actuators takes/take place by the planning means under defined conditions, with at least one condition being able to be set by the operator, in particular via an input unit connected to the control. The new planning of the trajectories by means of the planning means can therefore be adapted under different criteria. Restrictions that result from the environment or from the characteristics of the working device can be taken into account here. Restrictions that result from the existing infrastructure can also ideally be taken into account.

Provision is made in a further embodiment that the settable condition is a maximum or minimum speed of one or more actuators, a minimum energy input, a shortest or fastest distance or a distance optimized using other criteria, or a position, in particular a starting or end position, or an offset value of the starting or end positions, of the working device.

In accordance with an alternative embodiment, no characteristic and synchronized points are determined, but the instantaneous actuator positions and speeds are rather detected and stored at every time section or sampling section in the learning mode and a trajectory optimum in time that is automatically moved to in the move through mode is generated on the basis of these data. The position paths detected for every actuator in the learning mode are retained here, i.e. are not adapted or changed, but the speed progressions are rather optimized. The speed of every actuator at every sampling step is scaled to obtain the trajectory optimum in time. Only one single scaling factor is used for every sampling step to retain the positional progression of every actuator. The trajectory optimum in time can be calculated by a planning means.

The general optimization problem for determining the trajectory optimum in time now comprises minimizing the end time of the trajectory. Furthermore, physical restrictions such as the maximum speed of the actuators, the maximum acceleration of the actuators, and/or the maximum conveying amount of a pump are optionally taken into account. Since the precontrol of the speed regulator requires an acceleration, the jerk is advantageously additionally restricted. The restrictions can be formulated as linear and nonlinear inequality restrictions and can furthermore be settable by the operator. The optimization variables are the previously mentioned scaling factors.

Provision is made in a further embodiment that the movement of the working devices in the learning mode takes place on the basis of a manual operation, for example via the master switches of the working device. The teaching of the trajectories can take place by an algorithm, alternatively or additionally to the manual operation, that detects the operating pattern of repeating work cycles of the operator. The movement routines can furthermore also be predefined by external systems such as planning tools, process control systems, a construction site management, etc.

Provision is made in a further embodiment that a first component is a superstructure slewably supported on an undercarriage of the working device and that a second component is a first boom element pivotably supported about a horizontal axis on the superstructure, with a third component optionally being a second boom element, for example a stick, pivotably supported on the boom.

The present application furthermore comprises a working device, in particular a material transfer machine or earth-moving machine, having a control for the carrying out of the method in accordance with the application. In this respect, the same advantages and properties obviously result as for the method in accordance with the application so that a repeat description will be dispensed with at this point.

A detection and representation of the trajectories in actuator coordinates is assumed in the present case. This is, however, only one of a plurality of possible conventions. Alternatively, a detection and working through in a different coordinate system, for example with respect to a tool center point (TCP) is likewise possible without this having an influence on the subject matter in accordance with the application. The different coordinate systems can optionally be converted into one another by corresponding transformations.

### BRIEF DESCRIPTION OF THE FIGURES

Further features, details, and advantages of the application result from the embodiments explained in the following with reference to the Figures. There are shown:

FIG. 1: an embodiment of a working device having a plurality of movable components in a schematic side view;

FIGS. 2a-c: trajectories of three actuators detected in the learning mode with characteristic points located by the method in accordance with the application;

FIG. 3: an enlarged detail of the trajectory shown in FIG. 2c;

FIGS. 4a-c: the trajectories shown in FIGS. 2a-c with the characteristic points classified as starting and end points by the method in accordance with the application being highlighted;

FIG. 5: an enlarged detail of the trajectory shown in FIG. 4c; and

FIGS. 6a-c: the trajectories shown in FIGS. 2a-c with points synchronized in time by the method in accordance with the application.

### DETAILED DESCRIPTION

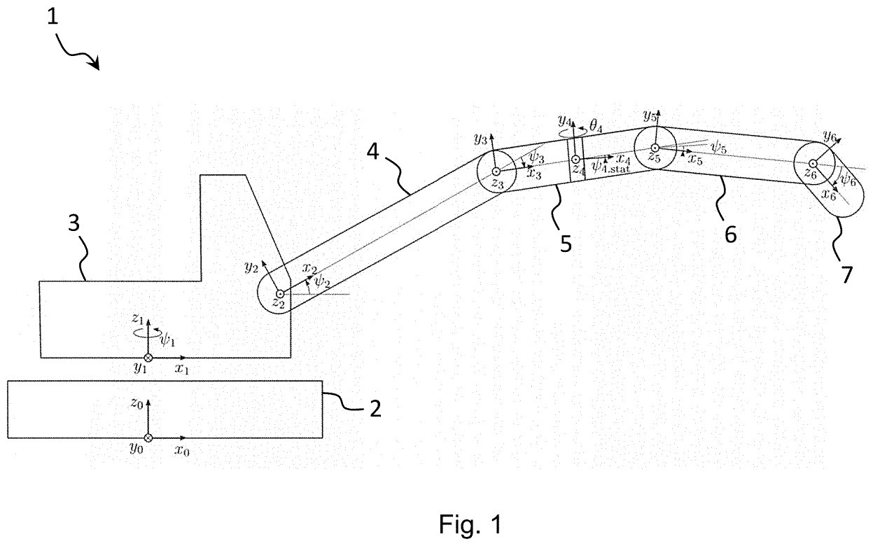

An embodiment of a working device 1 is shown in a schematic side view in FIG. 1 to illustrate the kinematics underlying the method in accordance with the application. The working device 1 comprises a superstructure 3 slewably supported on an undercarriage 2 and rotationally drivable by means of a slewing gear (not shown). A boom comprising a plurality of movable components 4-7 is connected to the superstructure 3 and a tool (not shown) such as an excavator bucket or a grab can be fastened thereto.

The different components (that also include the slewable superstructure 3 in the following) can move independently of one another by means of different actuators (not shown). In the case of the superstructure 3, it is, for example, the slewing gear; in the case of the boom components 4-7, hydraulic cylinders. An extending of a hydraulic cylinder arranged between the superstructure 3 and a boom component 4 thus, for example, effects a pivoting of this boom component 4 such that its end spaced apart from the superstructure 3 moves upward.

The working device 1 comprises a control that controls the individual actuators and thus controls the movement of the working device 1. The total movement of the working device 1 is here composed of the individual movements of the components 2-7 moved by the different actuators.

A separate coordinate system having the x, y, and z axes characterizing the respective component and having the angles ψ, θ is drawn in FIG. 1 with respect to the respective component disposed upstream to illustrate the kinematics for each component 2-7.

The number of moving components, their exact design, and the type and number of the associated actuators are naturally only shown by way of example here. The method in accordance with the application works, however, independently of the exact number and design of the components and actuators, in particular also with a larger number of components or degrees of freedom of movement.

A working device 1 having a superstructure slewable by means of a slewing gear, having a boom connected thereto and movable by means of a hydraulic cylinder, and having a stick connected to the boom and likewise movable by means of a hydraulic cylinder is assumed in the following to illustrate the method in accordance with the application. An actuator (slewing gear, hydraulic cylinder) is therefore associated with each of the three movable components (superstructure, boom, stick).

The positions of the actuators here determine the positions or dispositions of the respective components. In which coordinate system the movements are observed is absolutely irrelevant for the method in accordance with the application. In the present case, for reasons of simplicity, actuator coordinates are assumed so that, for example, the position of the superstructure is determined by the angle of the slewing gear and the positions of the boom and of the stick are determined by the extension positions or dispositions of the hydraulic cylinders. It is, however, generally equally possible to record and work through trajectories of the tool center point (TCP).

The control of the working device 1 has two modes, a learning mode and a work through mode. In the learning mode, the operator moves the working device 1 from a starting point to a destination point in a corresponding path, with it reporting this to the control. In this respect, so-called characteristic points 20 are stored for every actuator. In the following, points are generally understood as positions of the actuators. What characterizes a characteristic point 20 will be specified in more detail in the following.

To maintain the consistency of the movement, synchronization points 40 for the remaining actuators are likewise stored with respect to a characteristic point 20 of an actuator. Once the learning mode has ended, the operator signals this by a corresponding input. The recorded characteristic points 20 are subsequently inspected again and are sorted out as necessary by the control through a corresponding algorithm. The exact mode of operation will likewise be described further below.

In the work through mode, the stored points 30, 40 are automatically traveled to one after the other by the control by a corresponding control of the actuators. In this process, the actuators that reach the next point 30, 40 to be traveled to faster are synchronized to the slowest actuator by the control. This is done by means of an iterative process. So that the working device 1 does not become stationary at every point 30, 40 to be traveled to, a radius or a distance threshold value around every stored point 30, 40 is defined. If each of the actuators participating in the movement of the working device 1 is within this radius or distance threshold value, planning continues directly to the next stored point 30, 40. The planning or new calculation of the trajectory sections takes place with the aid of a planning means.

In the learning mode, the detected characteristic points 20, 30 of the actuators are stored on the basis of two algorithms. Algorithm 1 stores characteristic points 20+ and corresponding synchronization points 40 in dependence on the current speed of the actuators while the operator moves the equipment manually. Algorithm 2 is executed after the moving forward and sorts out characteristic points 20 that are very close to one another. These points 20 were stored, for example, due to vibrations on decelerating. It must again be pointed out at this point that the algorithms work for as many actuators as desired.

Algorithm 1 extracts characteristic points 20 for all the actuators. A characteristic point 20 is a point at which the speed of the actuator vₖ differs from the zero speed by a first threshold value (in the present case the sum or difference of a threshold value v_{TH} and a hysteresis v_{Hy}). In addition, a point is classified as a characteristic point 20 if the sign of the speed vₖ changes (i.e. on a reversal of direction) and the above condition is not met. Algorithm 1 is shown below using a pseudo-code example.

Data: Actuator speed
Result: Indicator whether a point is a characteristic point
charPoint = 0;
if abs(vₖ) ≥ (v_{TH} + v_{Hy}) and HyState == 0 then

charPoint = 1;
HyState = 1;

else

if abs(vₖ)< (v_{TH}− v_{Hy}) and HyState == 1 then

charPoint = 1;
HyState = 0;

else

if vₖ₋₁ · vₖ < 0 then

charPoint = 1;

end

end

end

The condition vₖ₋₁·vₖ<0 is satisfied on a change of sign; vₖ₋₁ here stands for the actuator speed previously recorded (i.e. on the preceding discretization step or sampling point), while vₖ stands for the current actuator speed. Setting the parameter charPoint=1 means that the corresponding point was classified as a characteristic point 20.

The use of the parameter HyState provides that not every point that satisfies the condition abs(vₖ)≥(v_{TH}+v_{Hy}) is classified as a characteristic point 20, but that rather only that point is again deemed to be a characteristic point 20 at which the instantaneous speed falls below the value (v_{TH}−v_{Hy}). The starting and end points of an actuator movement are therefore classified as characteristic points 20 by algorithm 1.

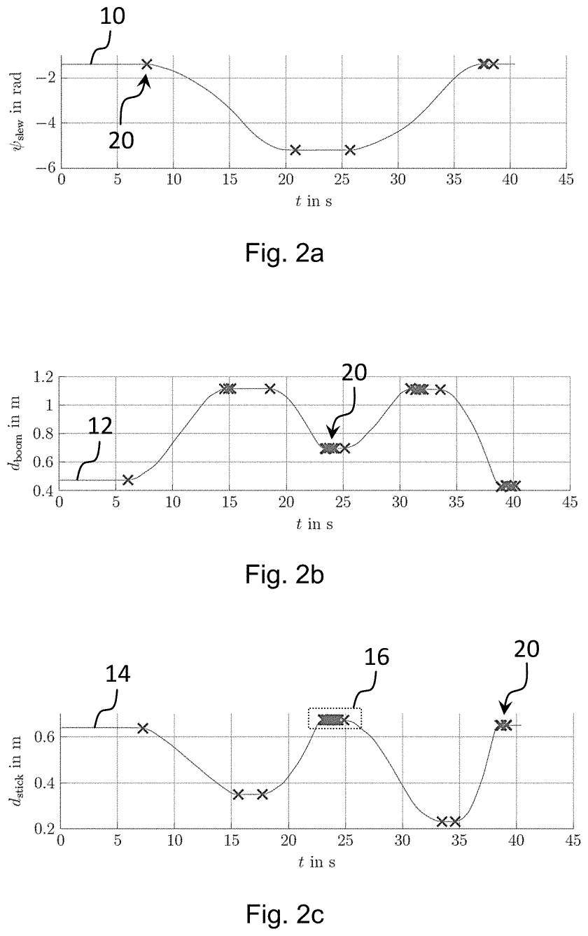

The result of algorithm 1 is shown in FIGS. 2a-c for the slewing gear (FIG. 2a), the boom (FIG. 2b) and the stick (FIG. 2c). Here, the located characteristic points 20 are marked as “x” along the trajectories 10, 12, 14 of the three actuators. It can be recognized that algorithm 1 has detected a characteristic point 20 for the slewing gear at the start of the movement at t=7.5 s. Characteristic points 20 were furthermore respectively detected at the stop (t=21 s) and at the restart (t=26 s) of the slewing movement. On the stopping of the movement at t=35 s, a plurality of consecutive characteristic points 20 were recognized following this in a short time. The reason for this is a low speed threshold value, a low hysteresis, and the overshooting of the slewing gear (i.e. a plurality of consecutive sign changes of the actuator speed). A plurality of points 20 are thereby categorized as characteristic.

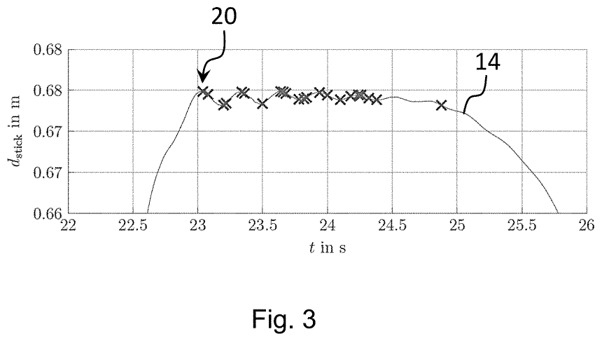

The found characteristic points 20 show up similarly for the boom (FIG. 2b) and the stick (FIG. 2c), with a larger number of characteristic points 20 being found there on stopping due to a more pronounced overshoot. This is illustrated for the stick in FIG. 2c. The region of FIG. 2c marked by the dotted box 16 is shown enlarged in FIG. 3. The overshoot behavior from which the locating of a plurality of consecutive characteristic points 20 results is clearly recognizable here.

It must generally be stated that all the start and stop points of the movement curves 10, 12, 14 are reliably detected by algorithm 1.

Algorithm 2, that is disposed after algorithm 1, should sort out characteristic points 20 that have a small spatial distance from one another. It is important here that the first and last characteristic points 20 respectively of a start/stop movement are retained. In algorithm 2, the respective spatial distance from the previous (“pₖ₋₁”) and the following (“pₖ₊₁”) characteristic points 20 are observed for every characteristic point 20. If both distances are smaller than a second threshold value p_{TH}, this characteristic point pₖ is sorted out. Algorithm 2 is shown below using a pseudo-code example.

Data: Characteristic points
Result: Unique characteristic points
for all characteristic points do

if abs(pₖ₋₁ − pₖ) < p_{TH} and abs(pₖ₊₁ − pₖ) < p_{TH} then

uniqueCharPoint = 0;

else

uniqueCharPoint = 1;

end

end

Setting the parameter uniquecharPoint=1 means that the corresponding characteristic point 20 was classified as a unique characteristic point 30, i.e. it was not sorted out.

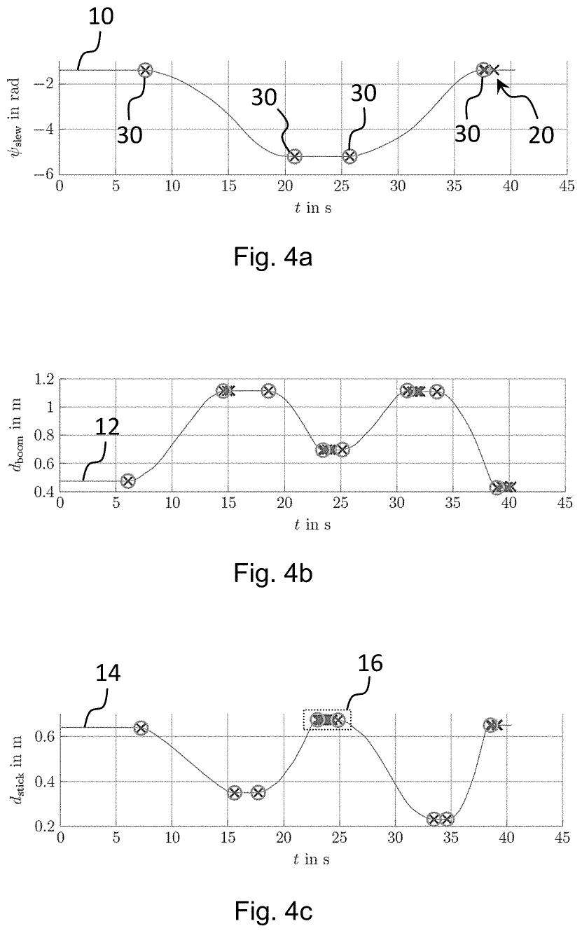

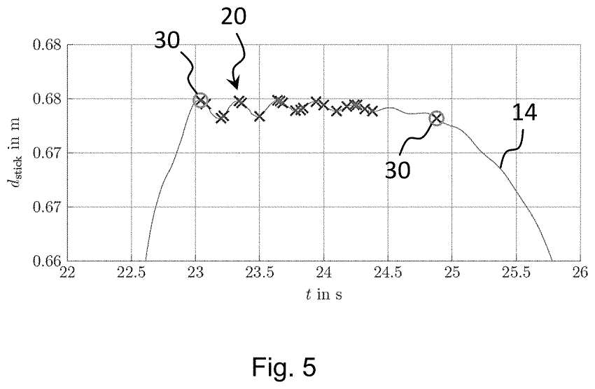

FIGS. 4a-c show for the three actuators (FIG. 4a: slewing gear, FIG. 4b: boom, FIG. 4c: stick) the trajectories 10, 12, 14 shown in FIGS. 2a-c with the characteristic points 20 that were located by algorithm 1 and that are marked as before by the symbol “x”. In addition, the unique characteristic points 30 filtered by algorithm 2 are shown by a circle symbol. The region marked by the dotted box in FIG. 4c is shown enlarged in FIG. 5. The characteristic points 20 and the unique characteristic points 30 are shown overlapping in FIGS. 4a-c and 5.

It can easily be recognized that algorithm 2 sorts out and no longer observes the characteristic points 20 that were caused by vibrations of the actuators. Only the start and stop points of the movements are identified as unique characteristic points 30. The total number of characteristic points 20 and thus the number of the points to be traveled to automatically in the work through mode is thus reduced by the use of algorithm 2. The filtering takes place, however, without any substantial information for the movement to be moved through automatically in the work through mode being lost.

So that all the unique characteristic points 30 are not traveled to separately for every actuator in the work through mode, the points 30 have to be synchronized in time for all the actuators. If therefore a unique characteristic point 30 is determined for an actuator, the positions of the other actuators at this time are also stored as points even though they do not have to be characteristic points 20 for these other trajectories 10, 12, 14. These additionally stored points are called synchronization points 40. All the points 30, 40 stored with respect to a trajectory 10, 12, 14 of an actuator are therefore synchronized in time in totality with the stored points 30+, 40 of the other actuators.

Respective time synchronized points 30, 40 are thus traveled to for all actuators in the work through mode and the total movement routine takes place based on the trajectories 10, 12, 14 detected in the learning mode. Generally, different paths result in this process (both in actuator coordinates and in joint or TCP coordinates) since the trajectories 10, 12, 14 of the individual components are newly planned or calculated by the planning means.

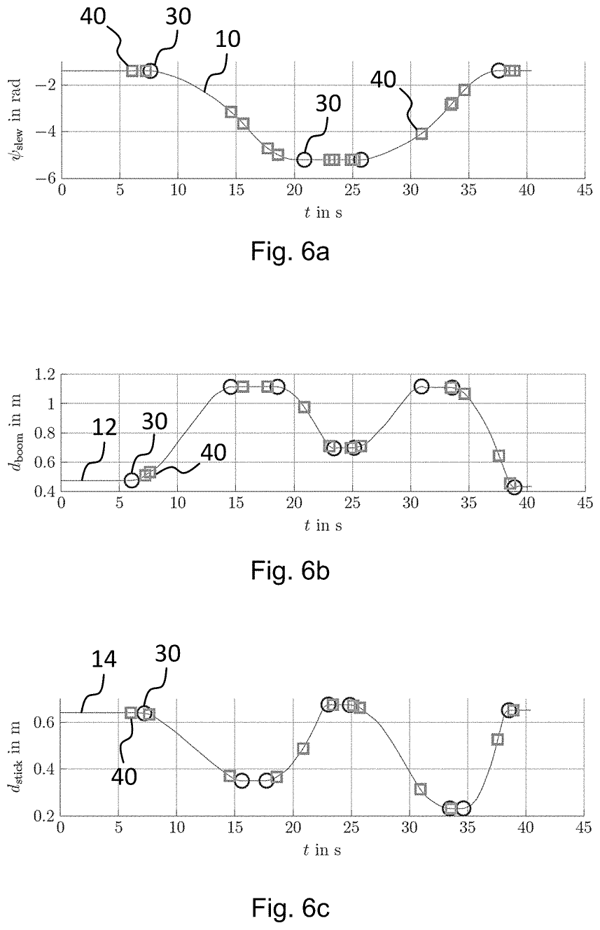

In FIGS. 6a-c, the unique characteristic points 30, each marked by a circle, to be traveled to in the work through mode and the synchronization points 40, each shown as a square, can be recognized for all the actuators (the trajectories 10, 12, 14) correspond to the paths shown in FIGS. 2a-c and 4a-c). It is ensured by the synchronization points 40 that, for example the boom, only starts the movement again at a corresponding slew angle (FIG. 6a) and not already on reaching a stop point 30, as would be the case with an isolated single movement without synchronization.

In the work through mode, the stored points 30, 40 stored for the different trajectories 10, 12, 14 are automatically worked through by a corresponding control of the actuators by means of the control. The number of points to be traveled to therefore comprises the unique characteristic points 30 located by algorithms 1 and 2 as well as the additionally stored synchronization points 40. This means that every point vector of this number of points or of this point matrix is traveled to one after the other.

The new planning of the trajectories 10, 12, 14 to be moved through from one point 30, 40 to the next point 30, 40 is performed by a planning means in the form of a trajectory generation algorithm or of a trajectory planner. This can, for example, be a Cⁿ trajectory planner for the position. “Cⁿ” here means “n-fold constantly differentiable with respect to the position”. How often the position trajectory or the newly calculated trajectory have to be differentiable depends on the pre-control for the actuator speed used. The parameterization of the trajectory planner takes place by the specification of the restrictions of the n derivations and the restriction of the input of the n+1th integrator that ideally shows a bang-bang behavior in an optimum manner. All known trajectory planners can be used for the new planning of the trajectories 10, 12, 14. For example, a C² trajectory can be planned on the basis of the pre-control used. The parameterization thus takes place via the specification of the positive and negative restrictions of the speed, acceleration and jerk.

To enable a traveling of the working device 1 that is as smooth as possible all the actuators should reach the next point 30, 40 to be moved through on their trajectory at the same time. The speed of the slowest actuator cannot be increased for this purpose since it has already reached its limit, typically the speed with hydraulic actuators. All the actuators therefore have to be synchronized to the slowest actuator. This takes place by varying the speed limit of the trajectory planner, in particular by means of an iterative process. The limits are adapted by a binary search here. Higher derivations can also be varied in this process.

Synchronization is generally not carried out to exactly the same end time in this search, but a freely definable parameter is rather defined as the threshold value or as the time window. If the end time of the trajectory 10, 12, 14 to be synchronized is within this time window around the end time of the slowest actuator, the synchronization is successfully ended. The time window can optionally be set or changed by the operator. It must be noted here that the algorithm for the synchronization works for any desired number of actuators. In addition, different trajectory planners can be used by the corresponding parameters.

If the trajectories 10, 12, 14 for all the actuators are planned for the respective next point 30+, 40, they are provided to the subordinate regulator as reference values. The generated trajectories 10, 12, 14 are evaluated for this purpose at every discrete time section. The increment of the discretization can be parameterized as desired here. If all the position trajectories or trajectories 10, 12, 14 are located within one parameterizable radius or distance threshold value around the desired points 30, 40 to be traveled to, the calculation of the next trajectory sections of the actuators, including the time end point synchronization, takes place at the next points 30, 40 to be traveled to. The current reference values of every trajectory 10, 12, 14 are used as the starting values for the trajectories 10, 12, 14 so that a process results that is as smooth as possible. The distance threshold values can here be parameterized separately for every point 30, 40 and for every actuator.

In accordance with the application, at least one parameter of the automatic movement carried out in the work through mode can be varied. Provision can be made for this purpose that the operator of the working device 1 can respectively specify the speed of all the actuators via an input. For this purpose, a separate input means can be provided or said operator can use the existing input means (e.g. master switches) for the manual control of the working device 1. It is furthermore conceivable that the parameters or conditions of the trajectory planning are adapted automatically in dependence on the environmental conditions such as the temperature and/or on the power of the working device 1 to achieve an ideal management behavior.

The new planning of the trajectories 10, 12, 14 by means of the planning means can be adapted under different criteria. Restrictions that result from the environment or from the characteristics of the working device are taken into account here. Examples for variable parameters include the minimum energy input, a small processing time, a shortest distance, or a small deviation from the taught trajectories 10, 12, 14. Restrictions that result from the existing infrastructure can also ideally be taken into account. It is additionally advantageously possible to suitably shift the take-up and/or unloading position if necessary. Provision can also be made for this purpose that an offset parameter can be fixed by which the start and/or end position of the movement is shifted automatically in each workstep.

The teaching of the trajectories 10, 12, 14 in the learning mode can take place alternatively or additionally to a manual performance of the movement or a manual operation by an algorithm that detects the operating pattern of the driver. In this case, the control recognizes repeating work cycles and generates corresponding trajectories 10, 12, 14 that can be worked through in the work through mode.

A major characteristic of the work through mode is that the trajectories 10, 12, 14 from the current point vector 30, 40 to the next point vector 30, 40 are respectively newly planned or calculated by the planning means under time synchronization aspects. It is possible in dependence on different parameters of the trajectory generation by the planning means that the speed of an actuator decreases or increases between two unique characteristic points 30 (that is between two start and stop points of a movement) due to the additionally inserted synchronization points 40.

This is considered particularly disruptive for the slewing gear. If. for example. the slewing gear is slewed by 180° and if the boom and the stick are moved simultaneously therewith, a detection of unique characteristic points 30 for the boom or stick can take place during the slewing movement. This has the consequence that a respective synchronization point 40 for the slewing gear is set between its starting and end points 30 at these times. The slewing gear should ideally travel from the starting slew angle to the end slew angle. Since, however, the slewing movement is newly planned by the planning means in each case from one point 30, 40 to the next point 30, 40, it is possible that the slewing gear reduces its speed at one of the added synchronization points 40.

This behavior can be recognized, for example, at t=15 s in the trajectory 10 of the slewing gear in FIG. 6a. At this time, a respective unique characteristic point 30 was detected as the start and stop points of the corresponding movements for the boom (FIG. 6b) on the one hand and for the stick (FIG. 6c) on the other hand and were correspondingly synchronized for the slewing gear (i.e. a respective synchronization point 40 was added), from which the kink in the trajectory 10 of the slewing gear representing a reduction in the slewing speed results.

A non-fixed synchronization of the trajectory 10 of the slewing gear and a synchronization of the only trajectories 12, 14 of the moved components (boom and stick) can be a remedy for this. The same detection of the unique characteristic points 30 takes place for this purpose by means of algorithms 1 and 2 as described above. In addition, the starting and end slew angles 30 of the slewing gear are detected. The boom and the stick are synchronized with one another at the respective point vector 30, 40. As soon as the next point 30, 40 requires a change of the slew angle, the trajectory 10 of the slewing gear from the starting slew angle 30 to the end slew angle 30 is directly planned. The remaining actuators are then controlled in accordance with the slew angle. A smooth travel of the slewing gear is thereby ensured.

If a job requires the repeated traveling to two positions, for example to a first position to take up material or a load and to a second position to unload material, it is possible that the movement taught in the learning mode is only recorded in one direction, e.g. from the take-up position to the unloading position. The order of the movement in the work through mode can subsequently be reversed by the operator or by the control. It is thus possible that the take-up position or the unloading position is traveled to in dependence on the current position of all the actuators in response to an operator input.

It is furthermore possible that the slewing gear does not stand at the take-up or unloading position at the start of a movement of the working device 1. It can therefore be sensible not to first travel the slewing gear to the start position, that is dependent on the desired movement (take-up or unloading), and only then to the desired end position, but rather to first travel the other actuators (i.e. the boom and stick) from the current position of the slewing gear. These movements 12, 14 take place until a change of the slew angle occurs or is required at the desired points 30, 40 to be worked through. The trajectory 10 of the slewing gear from the current position to the desired end position is only planned then.

An additional optional expansion relates to all the actuators except for the slewing gear. Material is typically taken up from a low height by the working device 1. The tool center point (TCP) is subsequently moved vertically upwardly. If the position of the TCP in the vertical direction in the learning mode is now higher than the TCP position of the first point 30, 40 to be worked through in the vertical direction, it is not sensible first to travel vertically downwardly and subsequently upwardly again before the slewing movement starts. All the desired point vectors 30, 40 that have a lower vertical TCP position than the current TCP position can therefore be skipped. The skipping is carried at a maximum up to the start of the movement of the slewing gear.

### REFERENCE NUMERAL LIST

1 working device
2 undercarriage
3 superstructure
4 moving components
5 moving components
6 moving components
7 moving components
10 trajectory of slewing gear
12 trajectory of boom actuator
14 trajectory of stick actuator
16 enlarged section
20 characteristic point
30 unique characteristic point
40 synchronization point

1. A method for an automatic movement of a working device, wherein the working device comprises a control and at least two components that are each movable independently of one another by means of an actuator controllable by the control; wherein the control has a learning mode and a work through mode; and wherein the working device is traveled automatically from a first position into a second position by a corresponding control of the actuator in the work through mode,
wherein
the control detects and stores data relating to individual movements of the components during a movement of the working device in the learning mode, with the control of the actuator taking place during the automatic movement of the working device in the work through mode on the basis of these data and with at least one parameter of the automatic movement of the working device being able to be set by an operator.

2. A method in accordance with claim 1, wherein the parameter is a maximum or minimum speed of one or more actuators, a minimum energy input, a shortest or fastest distance or a distance optimized using other criteria or a position, including a starting or end position, of the working device.

3. A method in accordance with claim 2, wherein the control detects trajectories of the actuators at discrete time intervals in the learning mode, with the detected data comprising instantaneous positions, including instantaneous speeds of the actuators.

4. A method in accordance with claim 3, wherein the control stores instantaneous actuator positions as characteristic points for every trajectory, with the characteristic points comprising the actuator positions at starting and/or at ending of an actuator movement and with the control classifying an instantaneous actuator position at a specific time as a characteristic point if at least one condition with respect to the instantaneous actuator speed is satisfied.

5. A method in accordance with claim 4, wherein the condition is satisfied when the instantaneous speed of the actuator exceeds a first threshold value at the start of an actuator movement or falls below it at the end of an actuator movement and/or if the sign of the instantaneous speed of the actuator changes.

6. A method in accordance with claim 5, wherein the control only stores those characteristic points whose distance from a directly preceding and/or following characteristic point exceeds a second threshold value.

7. A method in accordance with claim 6, wherein, in the learning mode, the control additionally stores the actuator positions not classified as a characteristic point for every trajectory at those times that correspond to the times of the detected characteristic points of the other trajectories so that the times of the actuator positions of one trajectory stored overall correspond to the times of the characteristic actuator positions of the remaining trajectories stored overall.

8. A method in accordance with claim 7, wherein the control controls the actuators such that all the actuators reach the actuator positions corresponding to one another in time simultaneously within a time window that is settable, with the speeds of all the actuators being adapted to the slowest actuator and with the adaptation taking place by means of an iterative process.

9. A method in accordance with claim 8, wherein the control controls the different actuators in the work through mode on the basis of the actuator positions stored for every trajectory, with the control comprising instructions for planning that calculate the trajectories to be worked through automatically on the basis of the stored actuator positions and with the actuators being controlled such that they follow the calculated trajectories.

10. A method in accordance with claim 9, wherein the planning means newly calculates the trajectories of the actuators to be worked through in each case sectionwise between two respective adjacent stored actuator positions, with the planning means calculating the next trajectory section up to the then following stored actuator positions as soon as the instantaneous position of an actuator falls below a settable distance threshold value with respect to the currently traveled to stored actuator position.

11. A method in accordance with claim 10, wherein the calculation of the trajectories by the planning means takes place under defined conditions, with at least one condition being able to be set by the operator, via an input unit connected to the control and with the at least one settable condition being a maximum or minimum speed of one or more actuators, a minimum energy input, a shortest or fastest distance or a distance optimized using different criteria, and/or a position.

12. A method in accordance with claim 3, wherein a trajectory optimum in time is calculated on the basis of the detected actuator positions and speeds, said trajectory being worked through automatically in the work through mode, with the possible paths detected for every actuator in the learning mode not being adapted, with the speed of every actuator being scaled at every sampling step, with only a single scaling factor being used for the scaling at every sampling step, and with physical restrictions of the actuators and/or the components such as maximum speeds of the actuators, maximum accelerations of the actuators, a maximum jerk of one or more actuators, and/or a maximum conveying amount of a pump being taken into account in the calculation of the trajectory optimum in time.

13. A method in accordance with claim 1, wherein the movement of the working device detected in the learning mode takes place on the basis of a manual operation.

14. A method in accordance with claim 1, wherein a first component is a superstructure slewably supported on an undercarriage of the working device; and in that a second component is a first boom element pivotably supported about a horizontal axis on the superstructure, with a third component being a second boom element, for example a pivotably supported on the boom.

15. A working device, having a control with instructions stored in memory for carrying out the method in accordance with the method of claim 1.
